(19) United States
(12) Patent Application Publication
(10) Pub. No.: US 2008/0040887 A1
(43) Pub. Date: Feb. 21, 2008

(54) Friction hinge for electronic apparatus

(76) Inventor: Harry L. Dickerson, Grayslake, IL (US)

Correspondence Address: GODFREY & KAHN S.C., 780 NORTH WATER STREET, MILWAUKEE, WI, 53202, US

(21) Appl. No.: 11/505,248

(22) Filed: Aug. 16, 2006

(51) Int. Cl. E05D 11/08

(52) U.S. Cl. 16/342; 16/337

(57) ABSTRACT

A hinge assembly mounts a video display screen to a surface, and more particularly to the passenger compartment of a vehicle. The hinge assembly allows for the pivotal attachment of a video display screen to a surface, preferably the ceiling of a vehicle, using a friction hinge. The hinge assembly may include a resilient washer that is attached to the hinge assembly on a pin. The resilient washer functions to limit axial movement of the hinge assembly along the pin and is adapted to prevent the hinge assembly from locking-up during rotational movement of the video display screen.

### BACKGROUND OF THE INVENTION

This invention relates generally to a friction hinge assembly for mounting a component to a surface. In particular, the invention relates to a hinge assembly for displaying and adjusting the degree of the tilt of a video display screen that is mounted within the passenger compartment of a vehicle.

As vehicles have evolved, entertainment devices have been added to make traveling more enjoyable. For example, video display screens have been used in automobiles, recreational vehicles, buses, boats, airplanes, trains, and the like, for providing entertainment and information to the passengers. Such video display screens are typically connected to a video playback device such as a digital video disc (DVD) player or a video cassette recorder (VCR) or electronic gaming systems. Such screens are typically mounted to the ceiling of the passenger compartment of a vehicle and can be flipped downward when a passenger desires to view the screen or flipped up for convenient storage.

A number of mounting systems have been proposed to allow a video display screen to be viewed by passengers when in use and hidden when not in use. Commonly, these video display screens are mounted to the ceiling of the passenger compartment of a vehicle and are movable between a generally horizontal storage position, which is flush against the vehicle ceiling, to a generally vertical viewing position, which is typically approximately 90 degrees from the storage position.

The current systems suffer from certain drawbacks and limitations. Accordingly, a need exists for an improved hinge assembly that adequately supports the video display screen at a viewing position, will not easily wear after prolonged use, is relatively inexpensive to manufacture, will maintain consistent torque, is relatively compact, will not lock-up during rotational movement of the video display screen, provides adequate support to hold the video display screen to the stationary surface and solves other problems associated with the existing systems.

### SUMMARY OF THE INVENTION

The present invention provides for an improved hinge assembly for mounting and displaying a video display screen to a surface, and more particularly to the ceiling of a vehicle. The hinge assembly allows for the pivotal attachment of a video display screen to a surface, preferably the ceiling of a vehicle, using a friction hinge.

In one embodiment of the present invention, the hinge assembly provides a constant holding torque in either direction between the storage position and the deployed position of the video display screen.

In one embodiment of the present invention, the hinge assembly incorporates at least one resilient member or disc spring into which the rotational shaft is inserted. The resilient member is located between a stationary member of the hinge assembly and at least one moveable part of the hinge assembly and functions to prevent the stationary parts and moveable parts from lock-up during rotational movement.

In one embodiment of the present invention, a cam is equipped with at least one lobe and is used to produce a reciprocating action when engaged or contacted with another part of the hinge assembly.

In one embodiment of the present invention, the hinge assembly is equipped with detent stops that allow for repeatable soft stops.

In one embodiment of the present invention, the video display screen can be supported and pivoted by two hinge assemblies located on either side of the video display screen. The two hinge assemblies may be connected if desired by a shared pin or a connecting bar.

In one embodiment of the present invention, the hinge assembly is equipped with a torsion spring that is adapted to provide a separate force on the hinge assembly to allow for easy accessibility when the user of the video display screen desires to use the video display screen. The torsion spring can be activated to allow the video display screen to pivot downward from the horizontal storage position.

In one embodiment of the present invention the hinge assembly incorporates a hollow pin adapted to allow at least one wire to run through the pin.

### DESCRIPTION OF THE DRAWINGS

FIG. 1 is a side elevational view of a hinge assembly in accordance with one embodiment of the present invention;

FIG. 2 is a front elevational view of the hinge assembly of FIG. 1;

FIG. 3 is a side elevational view of the hinge assembly of FIG. 1;

FIG. 4 is a perspective view of a hinge assembly in accordance with one embodiment of the present invention;

FIG. 5 is a side elevational view of the hinge assembly of FIG. 4;

FIG. 6 is a front elevational view of the hinge assembly of FIG. 4;

FIG. 7 is a top plan view of the hinge assembly of FIG. 4;

FIG. 8 is a cross-sectional view of the hinge assembly of FIG. 4 along lines 8-8 of FIG. 7;

FIG. 9 is a perspective view of a hinge assembly in accordance with one embodiment of the present invention;

FIG. 9a is a perspective view of an alternative embodiment of the hinge assembly of FIG. 9;

FIG. 10 is a top plan view of the hinge assembly of FIG. 9;

FIG. 11 is a side elevational view of the hinge assembly of FIG. 9;

FIG. 12 is a front elevational view of the hinge assembly of FIG. 9;

FIG. 13 is a cross-sectional view of the hinge assembly of FIG. 9 along lines 13-13 of FIG. 10;

FIG. 13a is a cross-sectional view of the hinge assembly of FIG. 9a;

FIG. 14 is a perspective view of a hinge assembly in accordance with one embodiment of the present invention;

FIG. 15 is a top plan view of the hinge assembly of FIG. 14;

FIG. 16 is a side elevational view of the hinge assembly of FIG. 14;

FIG. 17 is a front elevational view of the hinge assembly of FIG. 14;

FIG. 18 is a cross-sectional view of the hinge assembly of FIG. 14 along lines 18-18 of FIG. 15;

FIG. 19 is a bottom plan view of a hinge assembly in accordance with one embodiment of the present invention shown in an installed configuration;

FIG. 19a is a bottom plan view of an alternative embodiment of the hinge assembly configuration shown in FIG. 19;

FIG. 20A is a detail view taken from FIG. 19;

FIG. 20B is a detail view taken from FIG. 19;

FIG. 21 is a perspective view of a hinge assembly in accordance with one embodiment of the present invention; and

FIG. 22 is a side elevational view of the hinge assembly of FIG. 21.

### DETAILED DESCRIPTION OF THE PREFERRED EMBODIMENTS

The present invention is directed to a friction hinge assembly 12 for pivotably mounting a video display screen 10 (shown in FIG. 19) to a surface. As used herein, video display screen 10 means the video display screen 10, the housing for the video display screen 10 and any other structure that is used to frame the video display screen 10. Although the hinge assembly 12 preferably pivotably attaches a video display screen 10 to the ceiling of a vehicle, the hinge assembly 12 can be used for any movable display unit mounted on many surfaces, such as an interior surface of any type of vehicle, a storage housing unit that is attached to the ceiling of a vehicle, a recess located in the ceiling of a vehicle or the underside of a kitchen cabinet. For clarity, the ceiling of the passenger compartment of a vehicle is used herein as a representative example of a surface that the hinge assembly 12 can be mounted to and a video display screen 10 shall be used as a representative example of a component that can be mounted to the ceiling of a vehicle by the hinge assembly 12. One skilled in the art will understand that the present invention is suitable for pivotably coupling any object to any surface.

According to the present invention, a friction hinge assembly 12 is used to pivotably attach a video display screen 10 to the ceiling of a vehicle. The hinge assembly 12 is preferably constructed of metal, although other material can be utilized. With the use of the hinge assembly 12, the video display screen 10 can be pivoted downward from a generally horizontal storage position on the ceiling of a vehicle to any suitable desired angled position, preferably within about 90 degrees from the storage position. In the storage position, the video display screen 10 will preferably be generally parallel to or in planar alignment with or recessed in the ceiling of the vehicle. The hinge assembly 12 allows the video display screen 10 to be moved between a storage position and a deployed position. The hinge assembly 12 also frictionally maintains the video display screen 10 at a desired position anywhere between the storage position and the deployed position.

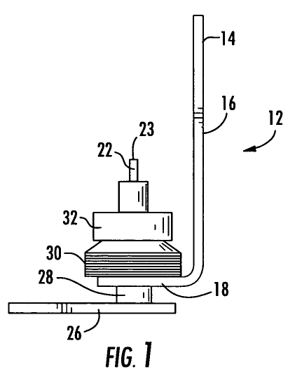

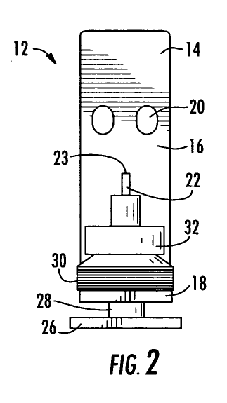

Referring now to the drawings, the hinge assembly 12 comprises a base 14 at least a portion of which can be attached to the ceiling of a vehicle. The base 14 is a stationary component that will not pivot when the moveable members of the hinge assembly 12 rotate and the video display screen 10 unit is pivoted. The base 14 is preferably L-shaped with a long arm 16 that is mounted to the ceiling and a short arm 18 with a generally circular opening that allows for the attachment of the short arm 18 of the base 14 to the remainder of the hinge assembly 12. The long arm 16 can be connected to the ceiling in any number of ways, including, but not limited to, through the use of at least one fastener or welding. If a fastener is used to connect the base to the ceiling, then the long arm 16 can include at least one opening 20 to receive the fastener. As demonstrated in FIGS. 1, 4, 9, 14, and 21, the base 14 can be designed in one of many different ways depending on the stationary surface that the base 14 will be mounted to.

The hinge assembly 12 also comprises a pin 22 with a first end 23 and a second end 24. The first end 23 of the pin 22 is inserted through at least the opening of the short arm 18 of the base 14. The first end 23 of the pin 22 and second end 24 of the pin 22 extend in either direction of the opening of the short arm 18 of the base 14. The pin 22 allows for the attachment of the other components of the hinge assembly 12 to the base 14 and specifically the short arm 18.

The hinge assembly 12 also comprises a video display bracket 26 that can be connected to a video display screen 10. The bracket 26 contains at least one opening to allow the first end of the pin to be inserted and thereby attach the bracket to the remainder of the hinge assembly 12. The bracket 26 may also have a second opening 27 to allow the bracket to be connected to the video display screen 10. The bracket 26 can be connected to the video display screen 10 in any number of ways, including, but not limited to, through the use of at least one fastener or by welding. Additionally, through the use of a desired fastener, the bracket 26 may be constructed so that the video display screen 10 can be detached or reattached as desired. Such feature can be useful for maintenance, removal or replacement of the video display screen 10. When the hinge assembly 12 is complete, the bracket 26 will pivot relative to the base 14 thereby allowing the video display screen 10 to pivot relative to the ceiling. As demonstrated in FIGS. 1, 4, 9, 14, and 21 the bracket 26 can be designed in one of many different ways depending on the size and shape of the video display screen 10 or other object that will be mounted to a stationary surface.

In one embodiment of the present invention, the bracket 26 and the short arm 18 of the base 14 can be separated by at least one spacer 28 to allow for a smoother rotation of the hinge assembly 12. In such embodiment, if the short arm 18 of the base 14 is already attached to the pin 22, the spacer 28 would be inserted onto the pin 22 before the bracket 26. The spacer 28 can be formed as a part of the bracket 26 or the spacer 28 can be formed as a separate component.

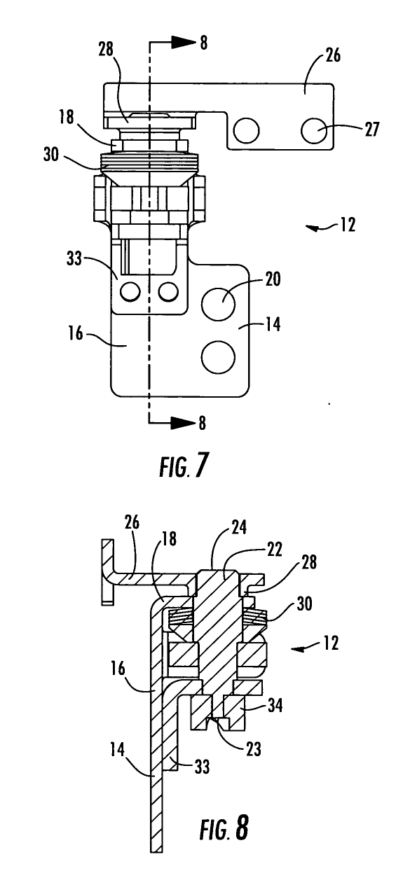

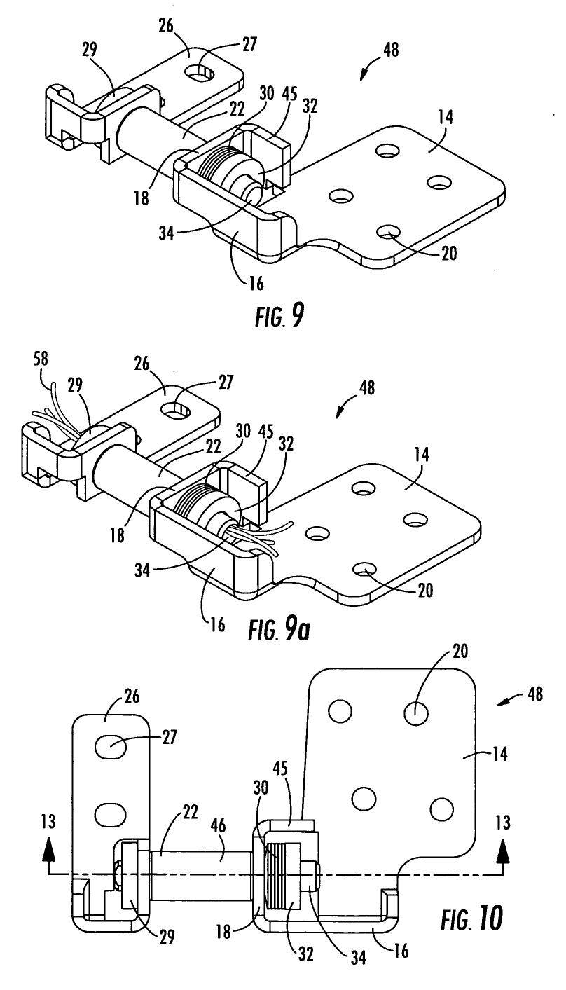

As shown in FIG. 9, in one embodiment of the present invention, a fixed or removable bushing 29 may be used to secure the bracket 26 to the pin 22.

The hinge assembly 12 also comprises at least one resilient washer 30 for applying axial compressive resilience to the hinge assembly 12. For instance, the resilient washer 30 can by a Belleville washer, spring washer, curved washer or tension washer. The resilient washer 30 has a generally circular shaped opening and is placed on the pin 22 through the opening. The resilient washer 30 is preferably disposed between the stationary short arm 18 of the base 14 and at least one movable part of the hinge assembly 12. The resilient washer 30 prevents the friction that is created during rotation of the hinge assembly 12 from locking the movable and stationary parts together during torque adjustment. Furthermore, the use of at least one resilient washer 30 will function place a load axially along the pin to limit axial movement of the components of the hinge assembly 12 along the pin 22 during rotational movement of the moveable components of the hinge assembly 12 around the pin 22. Unlike springs or other similar types of devices, the resilient washer 30 will maintain constant torque regardless of the position of the hinge assembly 12. Accordingly, the use of at least one resilient washer 30 can function to prevent malfunction and undue wear and tear of the hinge assembly 12. In one embodiment of the present invention, multiple resilient washers 30 are used to provide adequate flexibility by producing a higher torque or a hinge assembly 12 with higher loading capacity.

The hinge assembly can also incorporate a support member 32 that is inserted onto the pin 22 adjacent to the resilient washer 30. The support member 32 has a generally circular shaped opening and is placed on the pin 22 through the opening. The support member 32 is preferably generally the same diameter as the resilient washer 30. If a support member 32 is utilized and in position on the pin 22 it serves to compress the resilient washer 30.

The hinge assembly 12 can also include, if desired, a cam 34 that is preferably placed on the pin 22 closest to the first end 23 of the pin 22. The cam 34 functions to, among other things, perform a reciprocating action when the hinge is moved, such as activating or deactivating a switch. Accordingly in one embodiment of the invention, when the movable parts of the hinge assembly 12 rotate, the video display screen 10 pivots downward from the storage position and the cam 34 serves to activate a switch to automatically turn the video display screen 10 on. Alternatively, when the movable parts of the hinge assembly 12 rotate back to their initial position, the video display screen 10 pivots upward to the storage position and the cam 34 serves to deactivate a switch to automatically turn the video display screen 10 off.

For clarity in describing the function and placement of each component of the hinge assembly 12, the above-identified representative example of placement of hinge assembly 12 components on the pin 22 has been used. One skilled in the art will understand that the present invention can be assembled in numerous different ways and the components can be inserted through an end of the pin 22 in different order than has been described herein. For example, the cam 34 can be placed on the pin 22 first, then the support member 32, then at least one resilient washer 30, then the short arm 18 of the base 14, then a spacer 28 and finally the bracket 26.

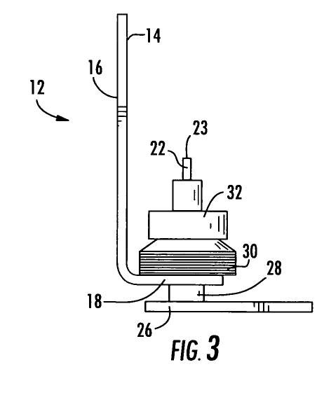

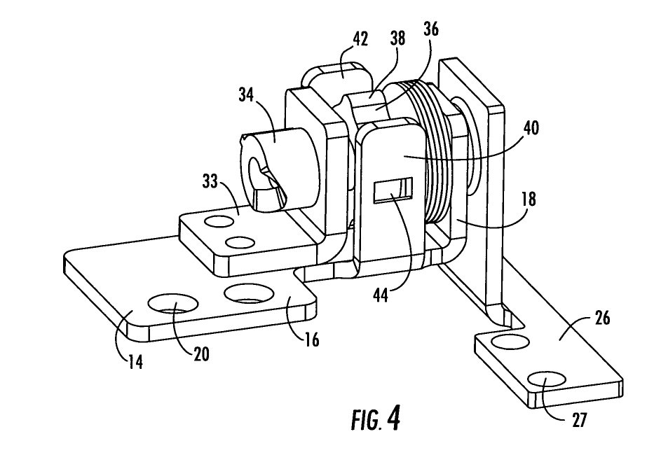

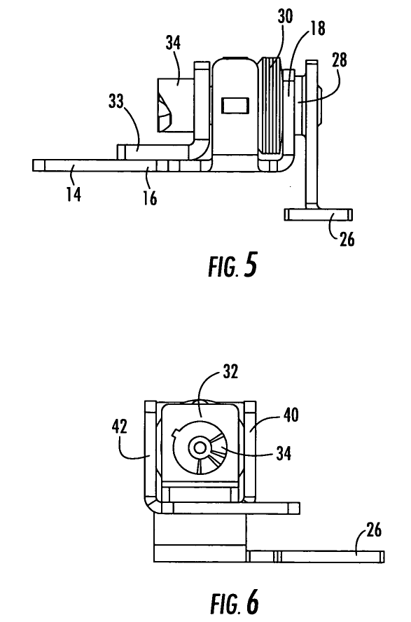

In one embodiment of the present invention, the hinge assembly 12 can also include a second cam 36. The second cam 36 has an opening and is also placed on the pin 22 through the opening. When the movably parts of the hinge assembly 12 rotate on the pin 22 relative to the base 14, the second cam 36 also rotates, thereby allowing the hinge assembly 12 to perform at least one additional function. For example, the second cam 36 may be formed with at least one lobe 38 and the base 14 of the hinge assembly 12 can incorporate at least one flange. As shown in FIG. 4, the base 14 can incorporate two flanges, a first flange 40 and a second flange 42. By their location on the base 14 of the hinge assembly 12, the first flange 40 and second flange 42 will not rotate relative to the pin 22. Accordingly, if a movable second cam 36 is incorporated on the pin 22, the first flange 40 and second flange 42 can assist the second cam 36 with the accomplishment of at least one additional function. For example, the first flange 40 and/or second flange 42 can incorporate at least one detent 44 that is of the appropriate size, shape and location to accept at least one lobe 38 from the second cam 36. The detent 44 can be an opening, as demonstrated in FIG. 4, a groove, catch or lever that temporarily locks the movement of the second cam 36.

If the second cam 36 incorporates at least one lobe 38, when the lobe 38 rotates relative to the pin 22 with the remainder of the moveable parts of the hinge assembly 12, the lobe 38 will temporarily snap into the detent 44 on the first flange 40 or second flange 42 and the entire hinge assembly 12 will stop rotating. This feature allows for repeatable soft stops. Accordingly, the detent 44 and lobe 38 may be positioned such that when the movably parts of the hinge assembly 12 are rotated, the video display screen 10 can be easily lowered to certain predetermined ideal viewing positions. In one embodiment of the present invention, the second cam 36 is equipped with two lobes and the first flange 40 and the second flange 42 each incorporate one detent 44. In this embodiment, both lobes will snap into their respective detents simultaneously. Alternatively, the lobe 38 and detent 44 can serve to prohibit the hinge assembly 12 from over rotating beyond a position that is 90 degrees from the horizontal storage position. The base 14 and specifically the long arm 16 of the base 14, may also be equipped with at least one detent that accepts at least one lobe from the second cam 36. Furthermore, as demonstrated in FIGS. 9 and 14, the base 14 can be constructed such that the short arm 18 is formed with an extension 45 that serves as a flange.

In one embodiment of the present invention, an angled support member 33 can also be used to support the pin 22 if a second cam 36 is present. As demonstrated in FIG. 4, the angled support member 33 is fixed to the base 14.

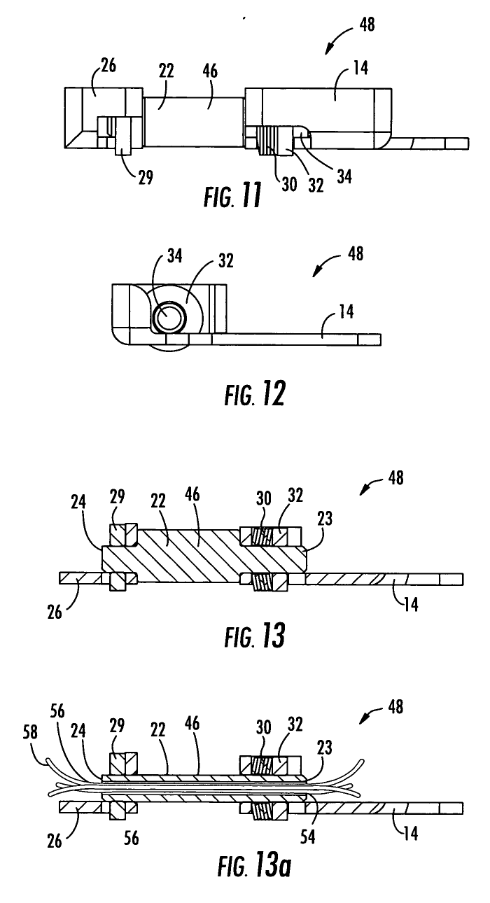

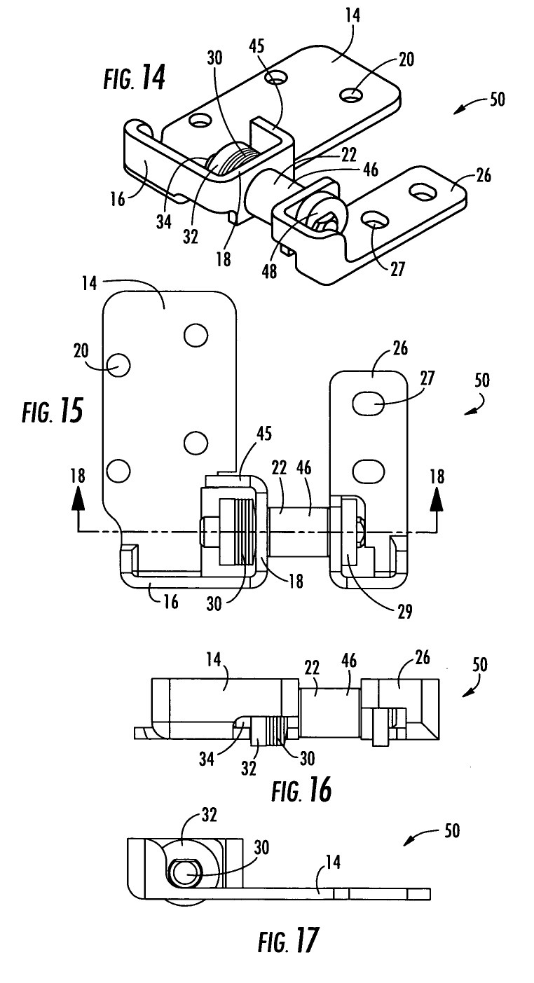

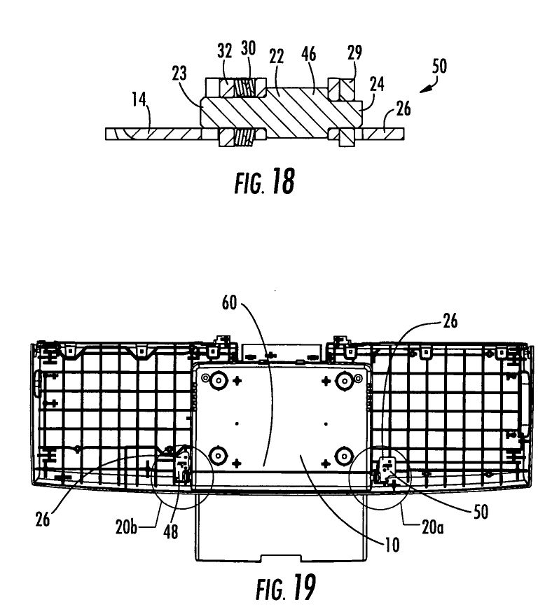

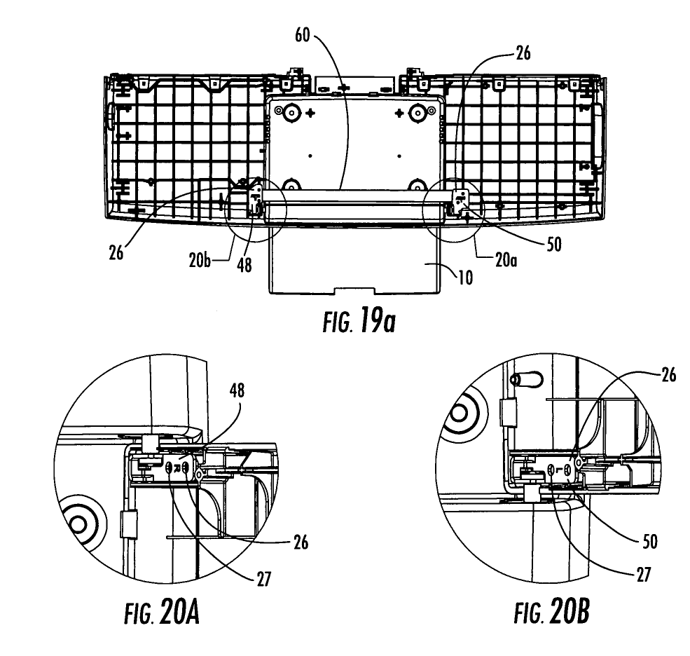

In one embodiment of the present invention, as shown in FIGS. 13 and 18, a pin 22 may be incorporated that varies in diameter. As demonstrated in FIGS. 13 and 18, the diameter of the pin 22 is preferably longer in the center 46 and shorter at the first end 23 and second end 24. Such an arrangement allows for proper attachment of the remainder of the hinge assembly 12 to the pin 22.

In one embodiment of the present invention, as shown in FIG. 9a and FIG. 13a, the pin 22 is hollow and has a first opening 54 at the first end 23 of the pin 22 and a second opening 56 at the second end 24 of the pin 22. If the pin 22 is hollow, at least one wire 58 can be inserted through one of the openings and out the other opening in the pin 22. Accordingly, in this embodiment of the invention, any necessary wire that is used for the video display screen 10 can be run through the pin 22.

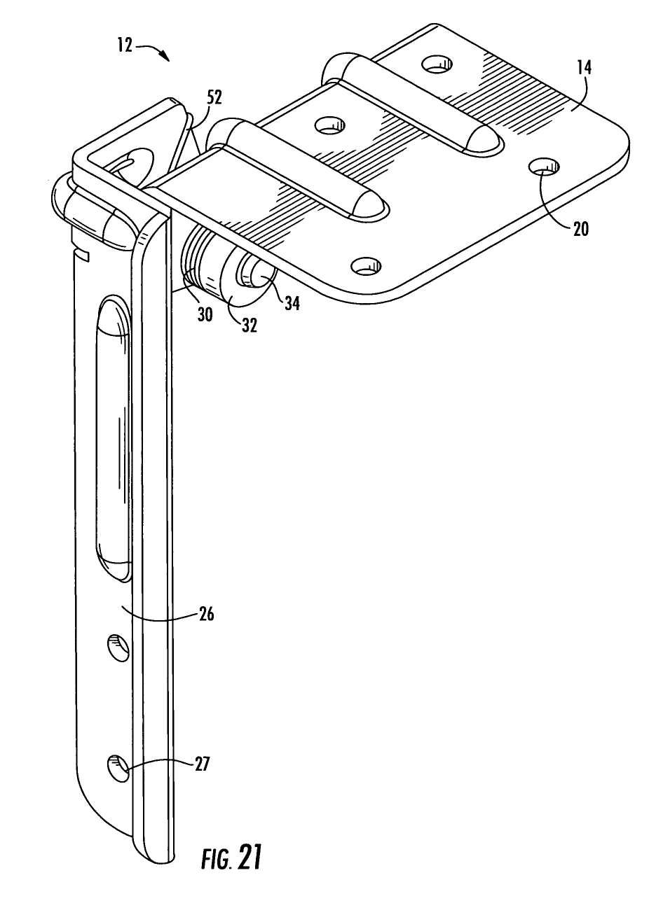

As shown in FIGS. 20A and 20B, the present invention can be constructed so that the hinge direction is either left handed or right handed. For example, as demonstrated in FIG. 9, the base 14 and the bracket 26 can be arranged on the pin 22 such that the video display screen 10 swings up and down to the left of the base 14. Additionally, as demonstrated in FIG. 14, the base 14 and the bracket 26 can be arranged on the pin 22 such that the video display screen 10 swings up and down to the right of the base 14. The right handed hinge assembly 48 or left handed hinge assembly 50 is achieved by the orientation of the hinge assembly 12 components on the pin 22.

Furthermore, for added support and stability of the video display screen 10, both a right handed hinge assembly 48 and a left handed hinge assembly 50 may be utilized together as demonstrated in FIGS. 19, 20A, and 20B. In this embodiment of the present invention, the base 14 from the right handed hinge assembly 48 and the base from the left handed hinge assembly 50 are attached to a stationary surface and are located on either side of the video display screen 10. The video display screen 10 is attached to the right handed hinge assembly 48 at its bracket 26 and the left handed hinge assembly 50 at its bracket 26. The right handed hinge assembly 48 and left handed hinge assembly 50 work in unison to pivot the video display screen 10 relative the stationary surface.

Furthermore, as demonstrated in FIG. 19a, the right handed hinge assembly 48 and a left handed hinge assembly 50 may be attached together by a common element 60, such as a bar, stamping or plate that spans between the right handed hinge assembly 48 and a left handed hinge assembly 50. Alternatively, the right handed hinge assembly 48 and a left handed hinge assembly 50 may share a common pin 22. When connected by a common element 60, the right handed hinge assembly 48 and left handed hinge assembly 50 work in unison to assure that the video display screen 10 is properly aligned relative to the stationary surface. For example, when the video display screen is rotated to its storage position, use of a common element 60 with the right handed hinge assembly 48 and left handed hinge assembly 50 can ensure that the video display screen 10 is moved to its proper storage position and deploy position. Furthermore, the use of a common element 60 will allow for precise closure of the video display screen 10 if the video display screen 10 is stored within a recess located in the ceiling of vehicle. For example when stored within such a recess, at least one gap will be created between the video display screen 10 and at least one edge of the recess within the ceiling. The use of a connection between right handed hinge assembly 48 and left handed hinge assembly 50 can ensure that the gap is consistently spaced from one end to the other.

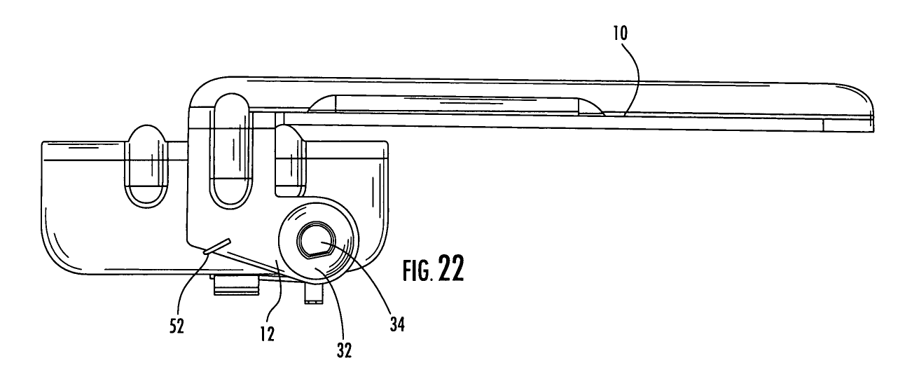

As demonstrated in FIGS. 21 and 22, in another embodiment of the present invention the hinge assembly 12 includes a torsion spring 52 that is used as means to overcome the torque of the friction hinge assembly 12. Accordingly, if the torsion spring 52 is used, the torsion spring 52 will provide a separate force on the hinge assembly that will allow for easy accessibility when the user of the video display screen 10 desires to use the video display screen 10. Preferably, when the torsion spring 52 is activated the video display screen 10 will pivot downward, preferably at an angle of approximately 20 degrees from the horizontal storage position. For example, the user may activate the torsion spring 52 in any one of a number of ways, including but not limited to, unhooking a latch or pressing a release button. Once the torsion spring 52 is activated, the video display screen 10 can automatically pivot downward approximately 20 degrees, then the user can manually position the video display screen 10 through the use of the friction hinge assembly 12 to the desired deployed location. Other means for biasing display screen 10 to pivot downward may also be used.

Although the invention has been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the hinge assembly 12 discussed herein may be implemented in a variety of embodiments, and that the foregoing discussion of certain of these embodiments does not necessarily represent a complete description of all possible embodiments. Additionally, benefits, other advantages, and solutions to the problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

What is claimed is:

1. A hinge assembly for mounting a component to a surface, allowing rotational movement of the component relative to the surface between a storage position and a deployed position, and frictionally maintaining the component at a desired deployed position, comprising:
a generally cylindrical shaped pin with two ends,
a bracket adapted to attach the hinge assembly to a component, wherein the bracket has at least one opening adapted to receive one end of the pin and wherein the bracket rotates relative to the pin;
a stationary base adapted to attach the hinge assembly to the surface, wherein the base has at least one opening adapted to receive one end of the pin;
a resilient washer with an opening adapted to receive one end of the pin; and
a support member adapted to retain the other components of the hinge assembly on the pin, wherein the support member has at least one opening adapted to receive one end of the pin.

2. The hinge assembly of claim 1 wherein the base is L-shaped and comprises a long arm adapted to attach to a surface and a short arm adapted to attach to the pin.

3. The hinge assembly of claim 2 wherein the short arm of the base is separated from the bracket by a spacer to allow for a smoother rotation of the hinge assembly.

4. The hinge assembly of claim 1 wherein the support member is adapted to compress the resilient member.

5. The hinge assembly of claim 1 further comprising an angled support member that is attached to the base and is adapted to support the pin.

6. The hinge assembly of claim 1 wherein the resilient washer is a Belleville washer.

7. The hinge assembly of claim 1 further comprising a cam, wherein the cam has at least one opening adapted to receive one end of the pin and wherein the cam rotates relative to the base.

8. The hinge assembly of claim 7 wherein when the cam rotates it automatically turns the video display screen on or off.

9. The hinge assembly of claim 1 further comprising a second cam wherein the second cam is formed with at least one lobe and when the second cam rotates, the lobe rotates, thereby allowing the hinge assembly to perform at least one additional function.

10. The hinge assembly of claim 1 wherein the pin varies in diameter from one end of the pin to the other.

11. The hinge assembly of claim 1 further comprising a torsion spring.

12. The hinge assembly of claim 1 wherein the pin is hollow.

13. The hinge assembly of claim 1 wherein the base is disposed between the bracket and the resilient washer and the resilient washer is disposed between the base and the cam.

14. A hinge assembly for mounting a component to a surface, allowing rotational movement of the component relative to the surface between a storage position and a deployed position, and frictionally maintaining the component at a desired deployed position, comprising:
a generally cylindrical shaped pin with two ends,
a bracket adapted to attach the hinge assembly to a component, wherein the bracket has at least one opening adapted to receive one end of the pin and wherein the bracket rotates relative to the pin;
a resilient washer with an opening adapted to receive one end of the pin;
a cam adapted with at least one opening adapted to receive one end of the pin;
a movable second cam that is formed with at least one lobe;
a stationary base adapted to attach the hinge assembly to the surface, wherein the base has at least one opening adapted to receive one end of the pin and wherein the base incorporates at least one flange that is formed with at least one detent that is adapted to receive the lobe from the second cam;
wherein, when the second cam rotates relative to the base, the lobe will temporarily snap into the detent.

15. The hinge assembly of claim 14, wherein the flange is formed with at least one opening to receive the lobe.

16. The hinge assembly of claim 14 wherein the flange is formed with at least one groove to receive the lobe.

17. A friction hinge system supporting a video display screen comprising:
two hinge assemblies each comprising,
a generally cylindrical shaped pin with two ends,
a bracket, adapted to attach the hinge assembly to a component, wherein the bracket has at least one opening adapted to receive one end of the pin and wherein the bracket rotates relative to the pin;
a stationary base, adapted to attach the hinge assembly to the surface, wherein the base has at least one opening adapted to receive one end of the pin;
a resilient washer with an opening adapted to receive one end of the pin; and
a support member, adapted to retain the other components of the hinge assembly on the pin, wherein the support member has at least one opening adapted to receive one end of the pin.

18. The friction hinge system of claim 17 wherein the friction hinge assemblies are connected by a common element.

19. A hinge assembly for mounting a component to a surface, allowing rotational movement of the component relative to the surface between a storage position and a deployed position, and frictionally maintaining the component at a desired deployed position, comprising:
a generally cylindrical shaped pin with two ends,
a bracket, adapted to attach the hinge assembly to a component, wherein the bracket has at least one opening adapted to receive one end of the pin and wherein the bracket rotates relative to the pin;
a resilient washer with an opening adapted to receive one end of the pin;
a support member, adapted to retain the other components of the hinge assembly on the pin, wherein the support member has at least one opening adapted to receive one end of the pin;
a cam, wherein the cam has at least one opening adapted to receive one end of the pin;
a movable second cam that is formed with at least one lobe;
a generally L-shaped stationary base with a long end and a short end adapted to attach the hinge assembly to the surface at the long end, wherein the short end has at least one opening adapted to receive one end of the pin, wherein the base incorporates at least one flange that is formed with at least one detent that is adapted to receive a lobe from the second cam, and wherein, when the second cam rotates relative to the base, the lobe will temporarily snap into the detent; and wherein the base is disposed between the bracket and the resilient washer and the resilient washer is disposed between the base and the cam.
